(19) United States
(12) Patent Application Publication
(10) Pub. No.: US 2026/0119916 A1
(43) Pub. Date: Apr. 30, 2026

(54) METHOD AND SYSTEM FOR MAINTAINING A CONTINUOUS CONVERSATION BETWEEN GENERATIVE AI MODELS AND END USERS

(71) Applicant: Intuit Inc., Mountain View, CA (US)

(72) Inventors: Ratul Kumar GHOSH, San Jose, CA (US); Mihir Naresh SHAH, Mountain View, CA (US); Devshree PATEL, San Jose, CA (US)

(21) Appl. No.: 18/926,103

(22) Filed: Oct. 24, 2024

(51) Int. Cl. G06N 5/04

(52) U.S. Cl. CPC G06N 5/04

(57) ABSTRACT

Certain aspects of the disclosure provide a method for maintaining a conversation with a user. The method decomposes a multipart question received from a user via a user interface associated with a device into two or more questions. Each respective question is assigned to an AI agent. For each respective question, the question is input to an AI agent to generate a follow-up question or an answer to the respective question. In response to the AI agent generating the follow-up question, the follow-up question is displayed to the user via the user interface. A user response to the follow-up question is input to the respective AI agent to generate an AI agent follow-up answer to the follow-up question. A large language model is used to generate a summary of answers to the two or more questions. The summary of answers is displayed in the user interface.

### BACKGROUND

### Field

Aspects of the present disclosure relate to user-based interactions with generative artificial intelligence models.

### Description of Related Art

Generative artificial intelligence (AI) agents, such as generative pre-trained transformers (GPTs), have revolutionized various industries. These AI agents have been trained on vast amounts of data to understand, generate, and transform human language. In recent years, automated customer-interaction engines that integrate generative AI agents with voice interactive response (IVR) systems, or chatbot systems, are expected to provide an operational efficiency that significantly improves the user experience. In particular, generative AI agents can dynamically generate human-like responses to user questions and make interactions with users more engaging and personalized. In addition, generative AI agents can be trained to incorporate company-specific information into generated answers, which may enhance the impressions users have of a company.

However, implementing AI technologies with IVR and chatbot systems has also come with challenges. Users often input to customer-interaction engines statements or answers to questions that are not fully expressed. The AI agents may present follow-up questions to try and elicit more fully expressed answers from the users. However, in many cases, an AI agent is not able to determine if a user's answer to a follow-up question is an actual response to the follow-up question or is an entirely new question. In such cases, the AI agent may end the conversation, transfer the conversation to another AI agent that does not have context for the conversation, or provide poor responses, all of which leads to user frustration and dissatisfaction.

Therefore, there is a need in the art for improvements to user interactions with customer-interaction engines.

### SUMMARY

Certain aspects provide a method for maintaining a conversation with a user, the method comprising: decomposing a multipart question, received from a user via a user interface associated with a device, into two or more questions; assigning each respective question of the two or more questions to an AI agent; for each respective question of the two or more questions: inputting the respective question to the AI agent to generate a follow-up question or an AI agent answer to the respective question; in response to the AI agent generating the follow-up question: displaying the follow-up question to the user via the user interface associated with the device; receiving a user response to the follow-up question from the user via the user interface associated with the device; and inputting the user response to the respective AI agent to generate a AI agent follow-up answer to the follow-up question; using a large language model (LLM) to generate a summary of answers to the two or more questions; and displaying the summary of answers in the user interface associated with the device.

Other aspects provide an apparatus comprising a planner configured to decompose a multipart question, received from a user via a user interface associated with a device, into two or more questions. The apparatus includes an executor engine configured to: input each respective question of the two or more questions to a plugin to generate a follow-up question to the respective question; present the follow-up question to the user via the user interface associated with the device; receive a response to the follow-up question from the user via the user interface associated with the device; and input the response to the plugin to generate an answer to the response; and a summarizer configured to generate a summary of answers to the two or more questions and display the summary of answers in the user interface associated with the device.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example conversation between an end user and a conventional customer-interaction engine that is unable to process the user's request for information.

FIGS. 2A-2B depict an architecture of the conventional customer-interaction engine.

FIG. 3 depicts an example conversation between an end user and an improved customer-interaction engine that is able to correctly process the user's multipart question.

FIGS. 4A-4D depict an example architecture of the improved customer-interaction engine.

FIG. 5 depicts an example method performed by the improved executor engine.

FIG. 6 depicts an example method for maintaining a conversation between generative AI agents and an end user.

FIG. 7 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for integrating generative AI agents (AI agents) into automated customer-interaction engines to maintain continuous conversations with end users and to generate coherent and meaningful answers to multipart questions.

As discussed above, generative AI technologies have been integrated with IVR systems, or chatbot systems, in an attempt to enhance customer service. When an end user logs into a typical customer-interaction engine, the engine performs user authentication to verify the user's identity before the user is permitted to ask questions or submit requests. Once the user has been verified, the engine uses an IVR or chatbot to prompt the user to ask a question or submit a request. For example, when the user ask a simple question, such as “Can I see my account balance? ”, the engine extracts the current account balance from the user's account and the IVR, chatbot, or an AI agent incorporates the account balance into a response, such as “Your current account balance is . . . ”

However, typical customer-interaction engines are not able to interpret cryptic customer statements or interpret multipart questions from users. The AI agents may attempt to obtain additional information from a user by asking a follow-up question. However, typical customer-interaction engine often fail to correctly interpret the answers from users. For example, suppose an end user presents a two-part question to a typical customer-interaction engine in which each part of the question is not specific with regard to the type of information requested. A typical customer-interaction engine may respond by presenting the user with a two-part follow-up question in which each part of the follow-up question tries to elicit more specific information from the user. However, if the user provides a specific answer to only one part of the two-part follow-up question or provides non-specific answers to both parts, the typical customer-interaction engine may terminate the conversation, transfer the conversation to an AI agent that does not have context for the questions and answers, or provide poor responses to the user's original two-part question.

Certain aspects of methods, systems, and apparatuses described herein solve the technical problems associated with typical customer-interaction engines described above. The methods, systems, and apparatuses described herein decompose a multipart question received from a user into two or more questions. Each respective question is input to an AI agent to generate a follow-up question or an answer to the respective question. When an AI agent generates a follow-up question, the user's follow-up answer to the follow-up question is input to the same AI agent that generated the follow-up question to ensure that the AI agent has context for understanding the follow-up answer. A large language model may be used to generate a summary of answers to the multipart question when all of the AI agents are finished answering all questions from the user. The summary of answers is the output presented to the user.

The methods, systems, and apparatuses described herein provide a number of technical advantage over typical customer-interaction engines by maintaining a continuous conversation chain between the different AI agents and the user, planning and executing new conversations with the user, asking follow-up questions that are designed to elicit more detailed answers from the user, terminating a conversation chain when the questions have been answered, transferring a portion of the planned conversation to specific AI agents as necessary, and generating a summary of answers from the different AI agents only after all of the AI agents used to answer questions have finished answering questions.

In certain aspects, the methods, systems, and apparatuses may use fallback AI agents to answer questions in cases where primary AI agents cannot answer a user's questions.

In certain aspects, the methods, systems, and apparatuses may use a planner in cases when a fallback AI agent is unable to answer customer's questions.

In certain aspects, the methods, systems, and apparatuses send each part of a multipart question to an AI agent that is relevant to the question.

In certain aspects, the methods, systems, and apparatuses may maintain an audit trail of follow-up conversations and snapshots of an execution graph in an operational database for future reference in answering similar questions from other users.

By addressing the technical problems of typical customer-interaction engines, the methods, systems, and apparatuses described herein improve the efficiency of customer interactions and significantly enhance each customer's level of satisfaction and impression of the company or organization that deploys the methods, systems, and apparatuses described herein.

### Example Method for Maintaining a Continuous Conversation between Generative Artificial Intelligence Agents and End Users

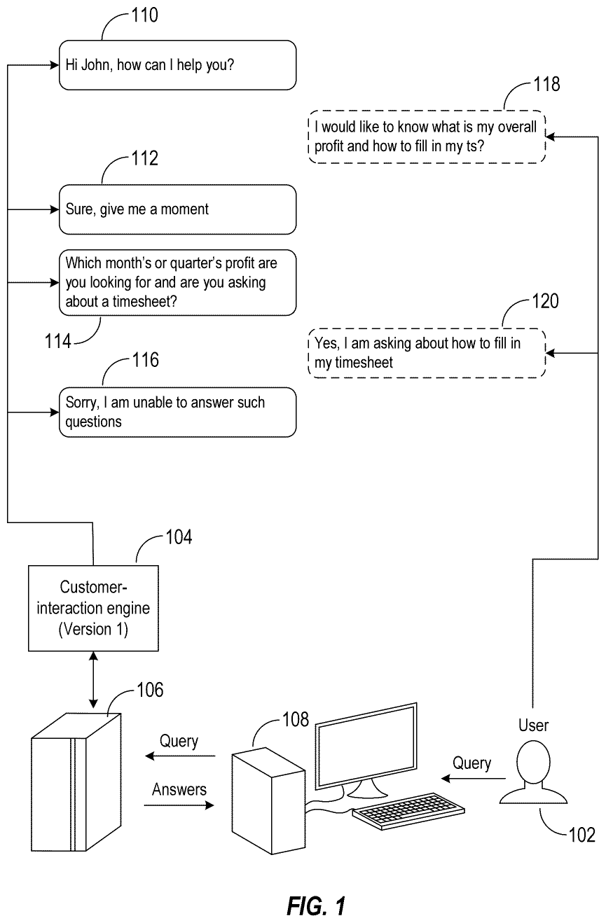

FIG. 1 depicts an example conversation between a user 102 and a conventional customer-interaction engine 104 that fails to process the user's request for information. In FIG. 1, the customer-interaction engine 104 is running on a computer server 106 that may be located on the premises of an organization or in the cloud. The user 102 logs into a customer account via a user interface (UI) of the customer-interaction engine 104. The UI may be provided by a web browser or an application running on the computer system 108. The UI can run on a tablet (not shown) or a smart mobile device (not shown). The customer-interaction engine 104 performs user authentication to verify the user's identity before the user 102 is permitted to ask questions or submit requests. The user 102 inputs queries for information via the user interface UI. A user prompt for entering user queries may be screened to check for profanity or sensitive information. The UI forwards the queries to the computer server 106.

In FIG. 1, an example conversation between the user 102 and the customer-interaction engine 104 are displayed in text bubbles. For example, questions 110 and 115 and answers 112 and 116 are generated by the customer-interaction engine 104. A two-part question 118 and the user's response 120 are generated by the user 102. The text bubbles may be displayed on the UI, enabling the user 102 to track the conversation with the customer-interaction engine 104. Alternatively, the statements and questions generated by the customer-interaction engine 104 may be played over a speaker (or another output device) and the user can input questions and answers via a microphone (or another input device).

After the engine 140 verifies the user's identity, the customer-interaction engine 104 begins the conversation by presenting the question 110. In this example, the user 102 responds with a two-part question 118. However, the first part regarding profit is not specific with respect to a time period to obtain profit and the second part contains an abbreviation “ts.” In this example, the customer-interaction engine 104 responds with a two-part follow-up question 114 to elicit more information from the user 102. The user response 120 only answers the second part of the two-part follow-up question 114 by confirming that the abbreviation “ts” in the second part of the question 118 refers to a timesheet. As a result, the customer-interaction engine 104 provides an answer 116 that fails to answer the user's original two-part question 118.

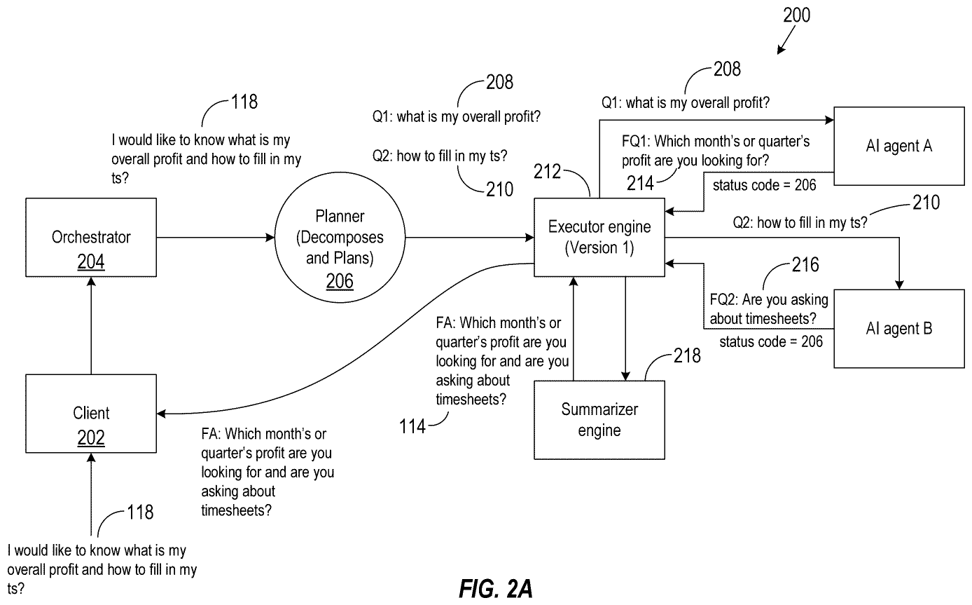

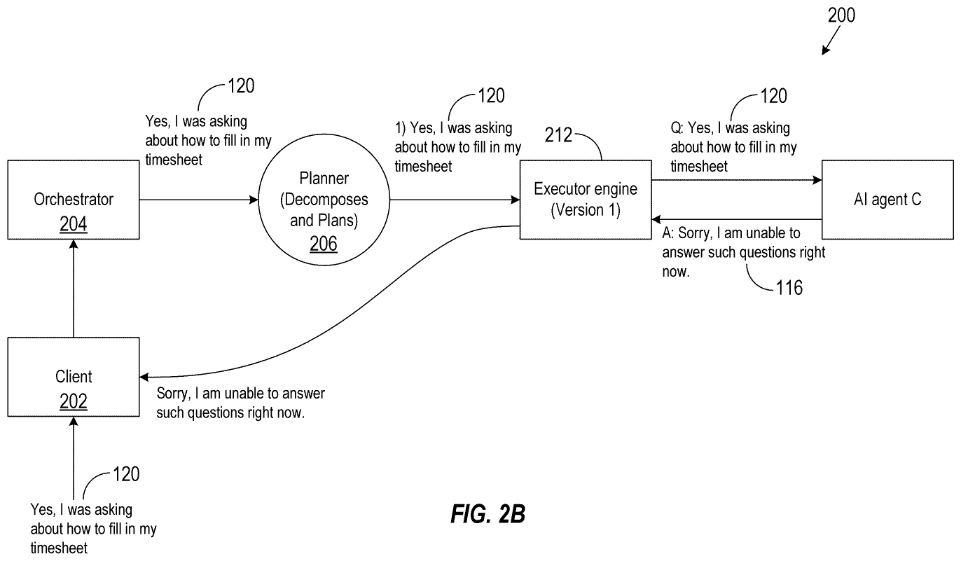

FIGS. 2A-2B depict an architecture 200 of the conventional customer-interaction engine 104 and demonstrates how the customer-interaction engine 104 fails to provide answers to the two-part question 118 in FIG. 1. In FIG. 2A, the architecture 200 includes a client 202 that interfaces with the UI displayed on the computer system 108. The client 202 is a computer program that receives queries from the UI and sends answers to the queries to the UI. For example, the client 202 sends the introductory question 110 in FIG. 1 to the UI. The client 202 forwards request received via the UI to an orchestrator 204.

The orchestrator 204 is a language model (e.g., a large language model (LLM) or small language model (SLM)) in this example that decomposes the two-part question 118 into a first question 208 and a second question 210 and forwards the questions 208 and 210 to a planner 206.

A language model (LM) is generally a type of machine learning model that is designed to understand, generate, and manipulate human language. More specifically, a LM is a probabilistic framework that determines the likelihood of a sequence of words or tokens. At its core, a LM attempts to predict the probability of the next word in a sentence given the preceding words. The model estimates these probabilities based on the patterns it learned during training. LMs are useful in natural language processing (NLP) and computational linguistics for performing a range of tasks involving human language.

LMs may be characterized by various components and capabilities. For example, a LM may include a vocabulary that defines the set of all possible words or tokens that the model can recognize and use. This includes common words, punctuation, and possibly domain-specific jargon. LMs may also consider a context, which refers to the preceding words in a sentence or sequence that the model uses to predict the next word. Modern LMs often incorporate extensive context windows, leveraging entire sentences or even paragraphs.

LMs may be implemented in various ways. For example, N-gram models predict the next word based on the previous N-1 words. Neural network-based LMs include Recurrent Neural Networks (RNNs), Long Short-Term Memory (LSTM) networks, and more Transformer models. These models capture more complex language patterns and context dependencies. The transformer architecture, introduced with models like BERT and GPT, utilizes self-attention mechanisms to handle long-range dependencies potentially more effectively than RNNs or LSTMs.

LMs are often trained using large corpora of text. The training process involves adjusting the model's parameters to minimize the difference between its predicted word probabilities and the actual word sequences in the training data. This is typically done via techniques like maximum likelihood estimation and gradient descent.

LMs have a wide array of applications, including: text generation (e.g., producing coherent and contextually appropriate text; machine translation (e.g., converting text from one language to another); speech recognition (e.g., converting spoken language into text); text summarization (e.g., condensing a long piece of text into a shorter summary); sentiment analysis (e.g., determining the sentiment expressed in a piece of text); and question answering (e.g., automatically providing answers to questions posed in natural language).

In sum, a language model is a sophisticated tool in NLP that analyzes and generates human language by understanding the probabilistic relationships between words and leveraging large datasets to learn these relationships. They form the backbone of many modern NLP applications, enabling machines to interpret, generate, and interact with human language.

LMs are sometimes distinguished as between a “large” LM (LLM) and a “small” LM (SLM) based on the size and complexity of the model, which affects their capabilities and applications. LLMs are often characterized by their large number of parameters, ranging from hundreds of millions to trillions of parameters. This extensive scale enables them to capture complex language patterns and nuances. LLMs are trained on vast datasets that often include diverse and extensive sources of text from the internet, books, articles, and various other textual corpora (e.g., domain-specific corpora). The large volume of training data contributes to their broad generalization capabilities. Due to their size and comprehensive training, LLMs exhibit excellent language understanding and generation abilities. Relatedly, LLMs require significant computational resources for both training and inference. This includes, for example, powerful hardware such as multiple GPUs or TPUs and substantial memory and storage capacity.

SLMs have a smaller number of parameters, compared to LLMs, often ranging from tens of thousands to a few hundred million parameters. This relatively smaller size bounds their ability to capture complex language patterns. SLMs are often trained on smaller datasets compared to LLMs. The training data is typically more focused and less diverse, aimed at specific tasks or domains. While SLMs can still perform various language-related tasks, their performance is usually limited compared to LLMs. However, SLMs require significantly fewer computational resources for training and inference. They can be run on more modest hardware setups, making them suitable for applications with constrained resources or where quick deployment is essential.

Thus, LLMs offer enhanced performance and versatility at the cost of higher computational resource requirements, while SLMs provide a more resource-efficient solution with limitations in performance and capabilities. The choice between an LLM and an SLM depends on the specific application requirements and resource constraints.

Returning to FIG. 2A, The planner 206 receives the first question 208 and the second question 210 and prepares a plan for forwarding the questions to AI agents that can answer the questions. In this example, the planner 206 directs the executor engine 212 to send the first question 208 to AI agent A and send the second question 210 to AI agent B.

In the example of FIG. 2A, the AI agent A is not able to answer the question 208 and generates a follow-up question 214 and an HTTP status code 206, which indicates AI agent A cannot successfully complete the request. The AI agent B is not able to answer the question 210 and generates a follow-up question 216 and an HTTP status code 206, which indicates AI agent B cannot successfully complete the request. In this example, the AI agent A and the AI agent B require more information from the user 102. The executor engine 212 receives the follow-up questions 214 and 216 from the AI agent A and AI agent B, respectively, and forwards both follow-up questions 214 and 216 to a summarizer engine 218.

The summarizer engine 218 is a language model (e.g., an LLM or SLM) that combines the follow-up questions 214 and 216 into the two-part follow-up question 114 (See FIG. 1). The executor engine 212 retrieves the two-part follow-up question 114 from the summarizer engine 218 and sends the two-part follow-up question 114 to the client 202. The client 202 displays the two-part follow-up question 114 in the UI as shown in FIG. 1.

In FIG. 2B, the user response 120 in FIG. 1 is sent to the client 202. The client 202 sends the user response 120 to the orchestrator 204, which forwards the user response 120 to the planner 206. However, the orchestrator 204 has no context for the user response 120. In other words, the orchestrator 204 does not know that the user response 120 is an answer to the follow-up question 216. As a result, the orchestrator 204 mistakenly identifies the user response 120 as a new request and the planner 206 assigns the user response 120 to AI agent C. The planner 206 forwards the user response 120 to the executor engine 212 with instructions to send the user response 120 to AI agent C. The executor engine 212 then sends the user response 120 to AI agent C. However, AI agent C has no context for the user response 120 and cannot process the request. As a result, AI agent C generates the AI agent answer 116, which the executor engine 212 forwards to the client 202. The client 202 displays the answer 116 in the UI for the user 102 to see.

The operation described above with reference to FIGS. 1-2B fails for a number of reasons. First, the orchestrator 204 is not able to determine that the user response 120 is associated with the question 216 and should be sent to AI agent B. Second, the executor engine 212 did not store the state of the conversation when AI agent A and AI agent B sent corresponding follow-up questions 214 and 216 and the HTTP status code 206, indicating AI agent A and AI agent B had not completed processing the questions 208 and 210, respectively. Third, the orchestrator 204 simply treated the user response 120 as a new response and followed through on sending the user response 120 to AI agent C, which had no context for the user response 120. In this example, the executor engine 212 broke the conversation chain and the user 102 is likely dissatisfied with resulting answer 116.

### Improved Customer Interaction Architecture

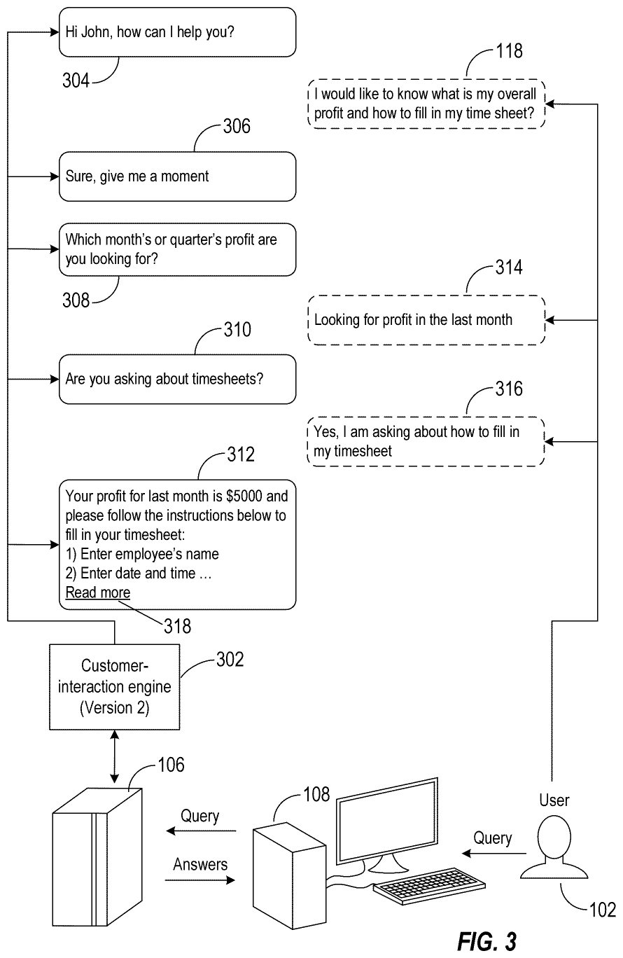

FIG. 3 depicts an example conversation between the user 102 and an improved customer-interaction engine 302 that is able to correctly process the user's multipart question. The improved customer-interaction engine 302 runs on the computer server 106 as described above. The user 102 logs into a customer account via a user interface (UI) of the improved customer-interaction engine 302. The UI may be provided by a web browser or an application running on the computer system 108. The UI can also be run on a tablet (not shown) or a smart mobile device (not shown). The improved customer-interaction engine 302 performs user authentication to verify the user's identity before the user 102 is permitted to ask questions or submit requests. The user 102 inputs queries for information via the user interface UI. In some aspects, the user prompt is screened to check for profanity or sensitive information. The UI forwards the queries to the computer server 106.

In FIG. 3, an example conversation between the user 102 and the improved customer-interaction engine 302 are displayed in text bubbles. For example, questions 304, 308, and 310 and answers 306 and 312 are generated by the improved customer-interaction engine 302. The two-part question 118, a user response 314 to the question 308, and a user response 316 to the question 310 are generated by the user 102. The text bubbles may be displayed on the UI, enabling the user 102 to track the conversation with the improved customer-interaction engine 302. Alternatively, the questions and answers generated by the improved customer-interaction engine 302 may be played over a speaker (or another output device) and the user can input questions and answers via a microphone (or another input device).

In this example, the user 102 has input the same two-part question 118 described above with reference to FIG. 1. Unlike the conventional customer-interaction engine 104, which asked a two-part follow-up question 114 in FIG. 1, the improved customer-interaction engine 302 ask separate follow-up questions 308 and 310 and waits to receive separate corresponding user responses 314 and 316 from the user 102. For example, the improved customer-interaction engine 302 ask the first follow-up question 308 and waits to receive the user response 314 from the user 102 before displaying the second follow-up question 310. The improved customer-interaction engine 302 generates a final answer 312 to the two-part question 118 based on the user responses 314 and 316. The final answer 312 includes a link 318 that the user 102 can click on to view the complete final answer about filling out a timesheet.

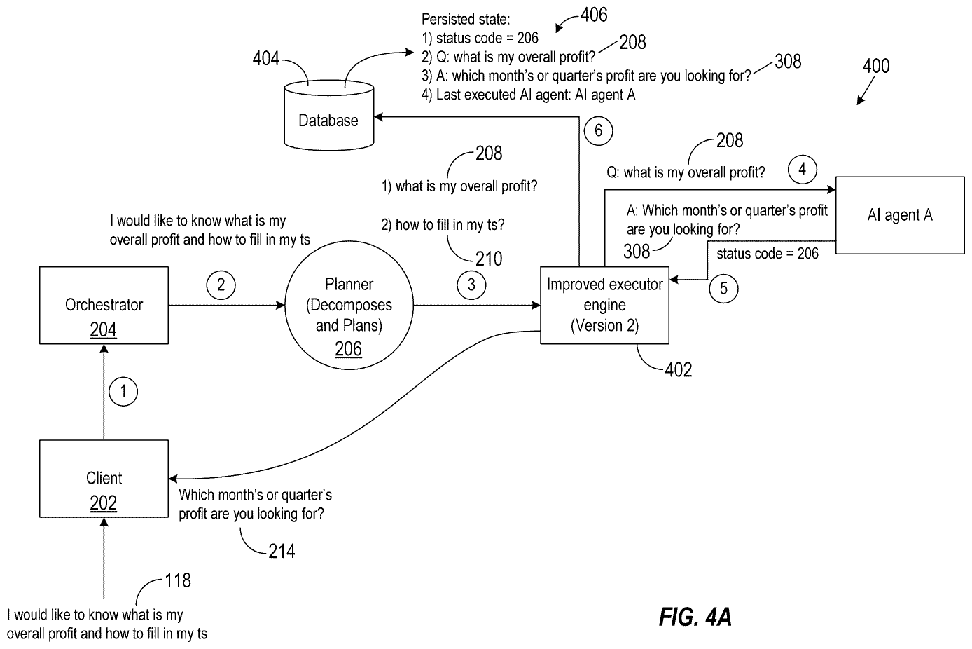

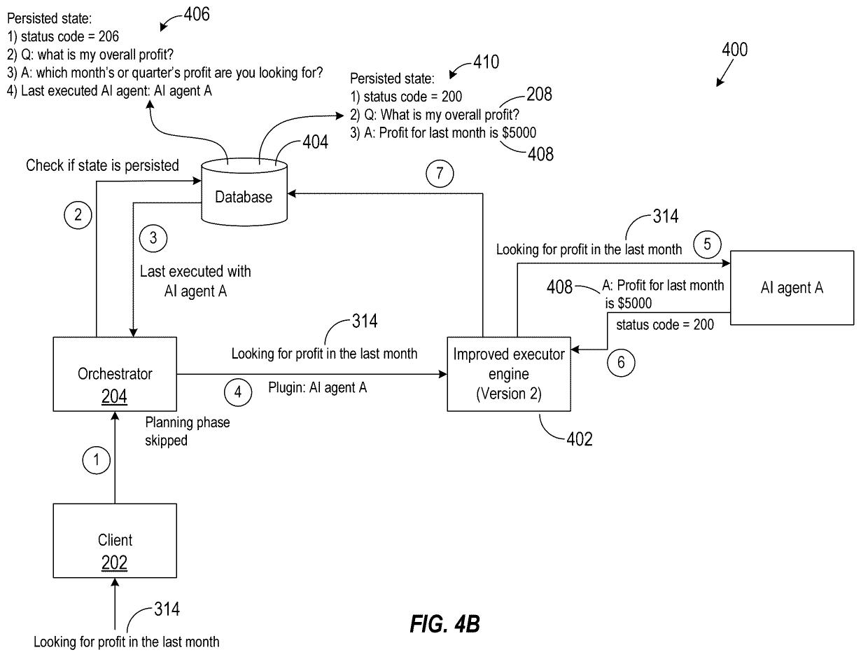

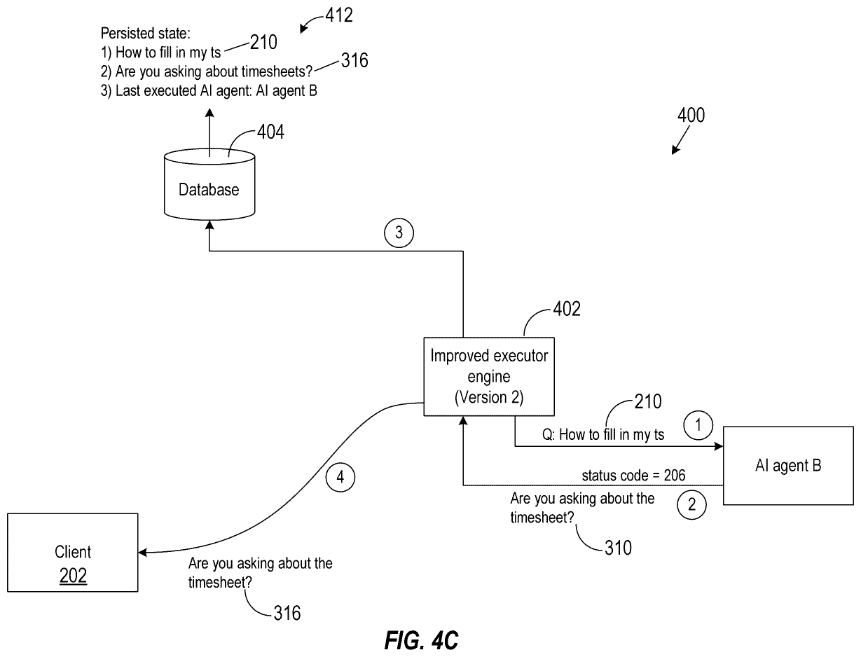

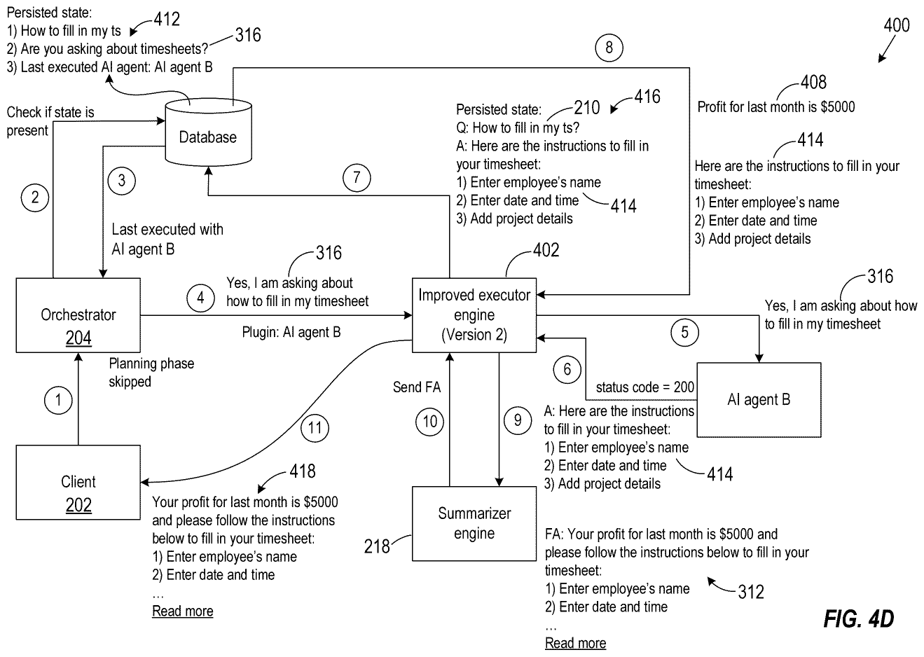

FIGS. 4A-4D depict an architecture 400 of the improved customer-interaction engine 302 and demonstrates how the improved customer-interaction engine 302 provides answers to the two-part question 118. In FIGS. 4A-4B, directional arrows are identified with circled numbers to represent the order in which questions and answers are passed to components of the architecture 400. The components in this example are the client 202, the orchestrator 204, the planner 206, an improved executor engine 402, and the AI agents. Each of the FIGS. 4A-4D corresponds to an execution graph in which the directional arrows are edges of the graph and the components of the architecture 400 are nodes of the graph.

The AI agents are configured to answer or respond to questions received from the improved executor engine 402 in one of four ways. First, an AI agent can ask a follow-up question and an HTTP status code 206, indicating that the AI agent is not finished and needs more information from the user 102 in order to generate an answer to the question. Second, an AI agent can generate an AI agent answer to user's question and an HTTP status code 200 indicating that the question has been answered by the AI agent. Third, the AI agent can generate a response with an error message and an HTTP status code 421 indicating that the AI agent cannot answer the question. Fourth, the AI agent can responds with an error message and an HTTP status code 422 indicating that there is sensitive information in the user input. Note that while certain example HTTP status codes are used in the present description, other codes and code formats (e.g., non-HTTP) are suitable alternatives.

In FIG. 4A, the architecture 400 includes the client 202 that interfaces with the UI displayed on the computer system 108 as described above with reference to FIG. 2A. The client 202 forwards the two-part question 118 received via the UI to the orchestrator 204. The orchestrator 204 decomposes the two-part question 118 into the first question 208 and the second question 210 and forwards the questions 208 and 210 to a planner 206. The planner 206 receives the questions 208 and 210 and determines a plan of execution for sending the questions to AI agents that can answer the questions. In this example, the planner 206 identifies the first question 208 as the first question to be answered by AI agent A (shown in FIGS. 4A-4B) and the second question 210 as the second question to be answer by AI agent B (shown in FIGS. 4C-4D) after the first question 208 has been answered.

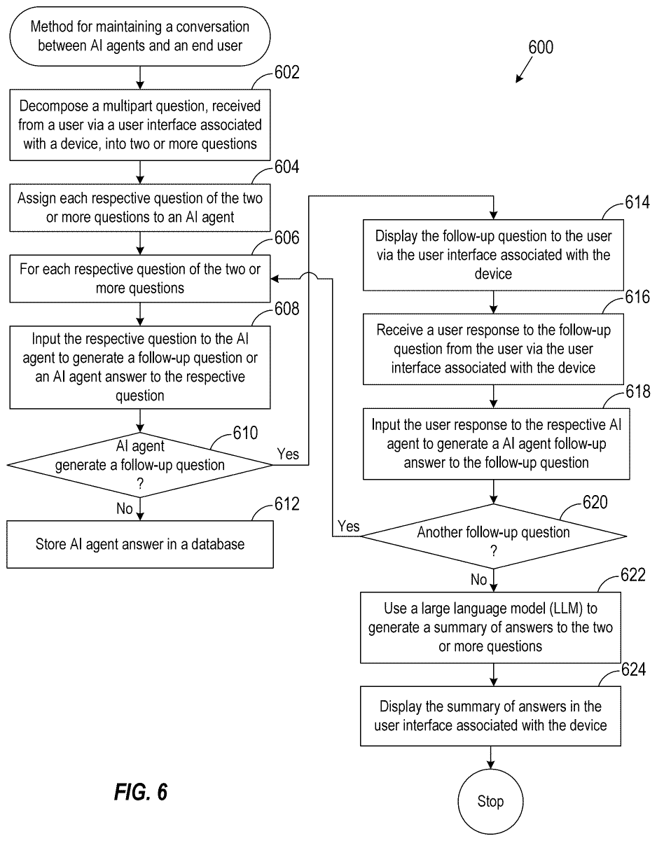

The planner 206 sends the questions and the plan of execution to the improved executor engine 402 described below with reference to FIG. 6. Unlike the executor engine 212 in FIGS. 2A-2B, the improved executor engine 402 performs the plan of execution by sending the first question 208 to AI agent A, storing the second question 210 in a database 404, and does not send the second question 210 to AI agent B until the first question 208 has been fully answered by the AI agent A.

In FIG. 4A, the improved executor engine 402 sends the question 208 to AI agent A, which responds with a follow-up question 308 and the HTTP status code 206. The orchestrator 204 stores a persisted state 406 of the AI agent A in the database 404. The persisted state 406 indicates that AI agent A is the last executed AI agent. The improved executor engine 402 sends the follow-up question 308 to the client 202, which displays the follow-up question 308 to the user 102 via the UI as shown in FIG. 3.

When the orchestrator 204 receives an AI agent answer from the AI agent and the HTTP status code 200, the AI agent answer is not sent back to the user 102. The AI agent answer is stored in the database 404 until the final answers to all of the questions of the multipart question have been obtained from the AI agents.

When the user 102 responds to a follow-up question with a user response, the orchestrator 204 checks the database 404 to determine whether the user response is a response to a follow-up question of a persisted state stored in the database 404. If the user response is a response to a follow-up questions of a persisted state with the HTTP status code 206 stored in the database 404, then the orchestrator 204 omits the planner 206 and directs the improved executor engine 402 to send the user response to the last executed AI agent.

In FIG. 4B, the orchestrator 204 determines the persisted state 406 is associated with the user response 314 in the database 404 and the AI agent A is the last executed AI agent. In this example, the orchestrator 204 sends the user response 314 and identification of the AI agent A to the improved executor engine 402. The improved executor engine 402 inputs the user response 314 to the AI agent A. The AI agent A generates an AI agent follow-up answer 408 and the HTTP status code 200, indicating that the AI agent follow-up answer 408 is an answer to the first question 208 of the two-part question 118. The improved executor engine 402 stores the first question 208 and the AI agent follow-up answer 408 in the database 404 as a persisted state 410 in the database 404.

In FIG. 4C, after the first question 208 of the two-part question 118 has been answered, the improved executor engine 402 sends the second question 210 to AI agent B, which responds with the follow-up question 310 and the HTTP status code 206. The improved executor engine 402 stores a persisted state 412 that indicates AI agent B is the last executed AI agent and is waiting to receive a user response from the user 102 to the follow-up question 310. The improved executor engine 402 sends the follow-up question 310 to the client 202, which displays the follow-up question 310 to the user 102 via the UI as shown in FIG. 3. The user 102 inputs the user response 316 to the follow-up question 310 as shown in FIG. 3.

In FIG. 4D, the orchestrator 204 determines the persisted state 412 is associated with the user response 316 in the database 404 and the AI agent B is the last executed AI agent. In this example, the orchestrator 204 sends the user response 316 and identification of the AI agent B to the improved executor engine 402. The improved executor engine 402 inputs the user response 316 to the AI agent B. The AI agent B generates an AI agent follow-up answer 414 and the HTTP status code 200, indicating that the AI agent follow-up answer 414 is the answer to the second question 210 of the two-part question 118. The improved executor engine 402 stores the second question 210 and the AI agent follow-up answer 414 as a persisted state 416 in the database 404.

In FIG. 4D, the improved executor engine 402 retrieves the AI agent follow-up answers 408 and 414 from the database 404 and inputs the follow-up answers 408 and 414 to the summarizer engine 218. The summarizer engine 218 is a language model (e.g., an LLM or SLM) that combines the follow-up answers 408 and 414 to obtain a final answer 312 to the two-part question 118. The summarizer engine 218 sends the final answer 312 to the improved executor engine 402, which sends the final answer 312 to the client 202. The client 202 displays the final answer 312 in the UI for the user 102 in FIG. 3.

In certain aspects, the improved executor engine 402 stores the persisted states in the database 404 so that persisted states can be retrieved and re-planning may be avoided by the planner 206. In other words, the improved executor engine 402 maintains the conversation history and enables the AI agents to generated AI agent follow-up answers to the user responses.

In certain aspects, if the improved executor engine 402 receives an HTTP status code 421, the improved executor engine 402 may call a fallback AI agent and updates/persists the execution graph and persisted state in the database 404. In the event the primary and fallback AI agents fail to answer a question, then the improved executor engine 402 invokes the re-planning phase with planner 206.

In certain aspects, if the improved executor engine 402 receives an HTTP status code 422, the improved executor engine 402 prompts the user to rephrase the question in order to try again.

In certain aspects, if the number of follow-up questions received by the orchestrator 204 from the AI agents exceeds a threshold then the orchestrator 204 prompts the user to rephrase the question. For example, the orchestrator 204 may prompt the user to ask fewer questions.

Once all the AI agents have answered (e.g., AI agent answers and AI agent follow-up answers) the questions and/or the follow-up questions, the summarizer engine 218 summarize the answers to obtain a final answer that is sent back to the user via the UI.

The improved customer-interaction engine 302 provides a number of technical advantages over the conventional customer-interaction engine 104. First, the improved customer-interaction engine 302 maintains a continuous conversation with the user 102. Second, the improved customer-interaction engine 302 asks the follow-up questions one at a time in order to elicit more detailed answers for each question of a multipart question before moving to a next question. Third, the improved customer-interaction engine 302 terminates a conversation when all of the questions or a multipart question have been answered. Fourth, the improved customer-interaction engine 302 generates the final answer only after the user 102 has provided user responses to all of the follow-up questions.

### Example Method for Managing User Questions and Follow-up Answers

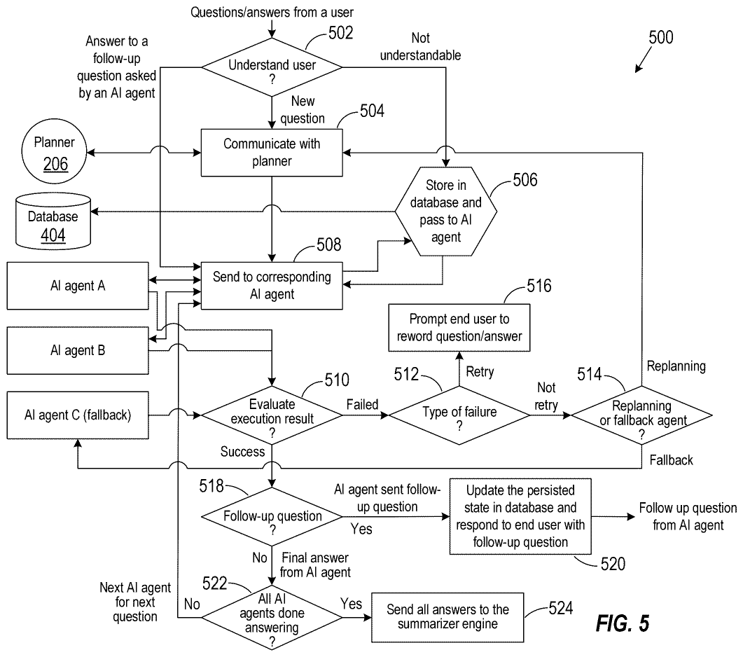

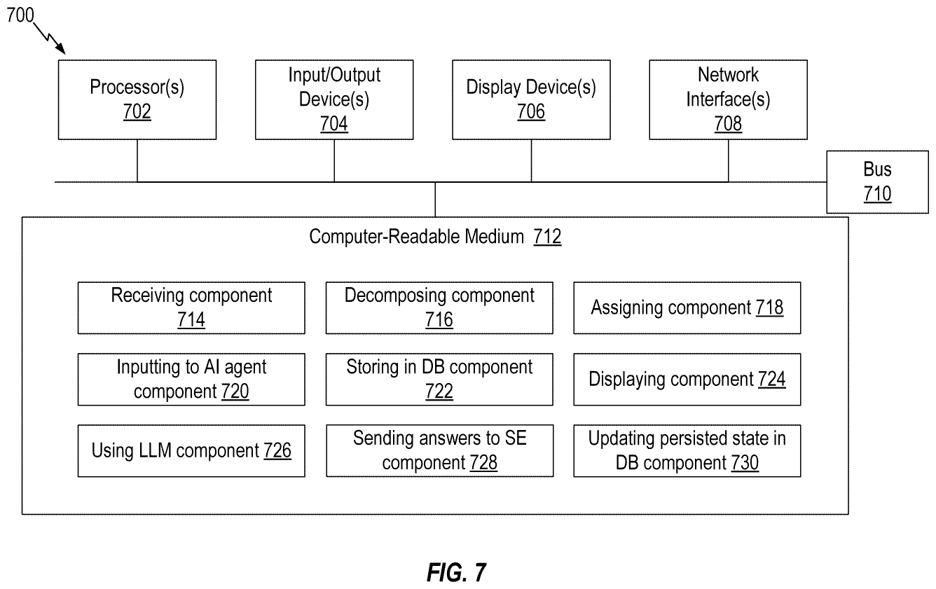

FIG. 5 depicts an example method 500 performed by the improved executor engine 402 of the improved customer-interaction engine 302. In one aspect, method 500 can be implemented by the processing system 700 of FIG. 7.

In block 502, each input received from the user 102 via the UI has been identified by the orchestrator 204 as a new question, a follow-up answer, or not understandable. If the input is a new question, control flows to block 504. If the input is a follow-up answer to a follow-up question, the planner 206 is skipped, as described above with reference to FIGS. 4B and 4D, and control flows to block 508. If the input is not understandable, control flow to block 506.

In block 504, the new question is passed to the planner 206. As described above with reference to FIG. 4A, the planner 206 determines which AI agent to send the new question to and control flows to block 508. The new question and AI agent identified by the planner 206 are passed to the improved executor engine 402.

In block 506, the not understandable response from the user is stored in the database 404.

In block 508, the new question is passed to the AI agent A or AI agent B in accordance with the plan of execution obtained from the planner 206 as described above with reference to FIG. 4A. The not understandable question or answer is sent to an AI agent to generate a response indicating the question or answer obtained from the user 102 is not understandable.

In block 510, the follow-up questions or answers generated by the AI agent A, AI agent B, and fallback AI agent C are evaluated based on corresponding HTTP status codes. If the HTTP status codes are 200 or 206 (in this example), then control flows to block 516. On the other hand, if the HTTP status codes 421 or 422 (in this example), then control flows to block 512. As above, other codes (and code types) may be used in other implementations with the same effects.

In block 512, if the HTTP status code is 421, then the follow-up question or answer from the AI agent A or AI agent B is an error and control flows to block 514. If the HTTP status code is 422, control flows to block 516 and the user is prompted to retry entering (e.g., rewording) the question or answer via the UI.

In block 514, if the AI agent A or AI agent B failed to answer the question from the user 102, the question is sent to the fallback AI agent C to try again at obtaining an acceptable follow-up question or answer to the user's question. If the fallback AI agent C fails to answer the question from the user 102, then control flows to block 504 and the planner 206 generates a different plan of execution, such as sending the question to a different AI agent.

In block 518, if the output from the AI agent is a follow-up question, control flows to block 520. Otherwise, if the output from the AI agent is an answer (e.g., an answer or follow-up answer) control flows to 522.

In block 520, the persisted state is updated in the database 404 and the follow-up question is sent to the user as described above with reference to FIGS. 4A and 4C.

In block 522, if all the AI agents are finished answering questions, control flows to block 524 and the answer are sent to the summarizer engine as described above with reference to FIG. 4D. Otherwise, control flows to block 504 and the next question is sent to one of the AI agents according to the plan of execution generated by the planner 206 as described above with reference to FIG. 4C.

In FIG. 5, the operations represented by blocks 510 and 512 create technical solutions to technical problems in conventional systems (described above) by ensuring that the conversation with the user 102 continues even in cases where the user 102 has input a question or follow-up answer that is not understandable by the AI agents. The operation represented by block 514 ensures that more than one attempt is made to obtain a follow-up question or answer to the user's question. The operation represented by block 522 ensures each question of a multipart question is answered separately and that all agents are finished answering the questions of a multipart question before a final answer to the multipart question is generated by the summarizer engine and presented to the user 102.

### Example Method for Maintaining a Conversation between Generative AI Agents and an End User

FIG. 6 depicts an example method 600 for maintaining a conversation between generative AI agents and an end user. In one aspect, method 600 can be implemented by the processing system 700 of FIG. 7.

Method 600 starts at block 602 with decomposing a multipart question, received from a user via a user interface associated with a device. The multipart question is decomposed into two or more questions as described above with reference to FIG. 4A.

Method 600 continues to block 604 with assigning each respective question of the two or more questions obtain in block 602 to an AI agent as described above with reference to FIG. 4A.

Method 600 continues to block 606 in which a for loop repeats the operations represented by blocks 608, 610, 612, 614, 616, and 618 for each respective question of the two or more questions as described above with reference to FIGS. 4A-4D. Repeating the operations represented by blocks 608, 610, 612, 614, 616, and 618 enables each respective question to be answered in full before moving on to the next respective question. The for loop avoids the technical problem created by sending the respective questions to the AI agents at the same.

Method 600 continues to block 608 with inputting the respective question to the AI agent to generate a follow-up question or an AI agent answer to the respective question as described above with reference to FIGS. 4B and 4D.

Method 600 continues to block 610 where, if the AI agent generates a follow-up question to the respective question, then control flows to block 614. On the other hand, if the AI agent generates an AI agent answer, then control flows to block 612.

Method 600 continues to block 612 with storing AI agent answer in a database as described above with reference to FIGS. 4A-4D.

Method 600 continues to block 614 with displaying the follow-up question to the user via the user interface associated with the device as described above with reference to FIGS. 3, 4A, and 4B.

Method 600 continues to block 616 with receiving a user response to the follow-up question from the user via the user interface associated with the device as described above with reference to FIGS. 3, 4B, and 4D.

Method 600 continues to block 618 with inputting the user response to the respective AI agent to generate an AI agent follow-up answer to the follow-up question as described above with reference to FIGS. 4B and 4D.

Method 600 continues to block 620 where if there is another respective follow-up question, then control flows to block 606 and the operations represented by blocks 608, 610, 612, 614, 616, and 618 are repeated for another respective follow-up question. Otherwise, control flows to 622.

Method 600 continues to block 622 with a large model (e.g., an LLM) to generate a summary of answers to the two or more questions as described above with reference to FIG. 4D.

Method 600 continues to block 624 with the summary of answers obtained in block 622 displayed in the user interface associated with the device as described above with reference to FIGS. 3 and 4D.

The method 600 provides a number of technical advantages over the conventional approaches to interacting with users as described above with reference to FIGS. 1-2B. First, the method 600 maintains a continuous conversation with the user 102. Second, the method 600 asks the follow-up questions generated by the AI agents one at a time in order to elicit more detailed answers to each question of the multipart question input by the user before moving to a next question. Third, the method 600 terminates a conversation when all of the questions have been answered. Fourth, the method 600 generates the final answer only after the user 102 has provided answers to all of the follow-up questions and the agents have responded to the follow-up answers from the user.

Note that FIG. 6 is just one example of a method, and other methods including fewer, additional, or alternative operations are possible consistent with this disclosure.

### Example Processing System for Maintaining a Conversation between Generative AI Agents and an End User

FIG. 7 depicts an example processing system 700 configured to perform various aspects described herein, including, for example, method 500 described above with respect to FIG. 5 and method 600 as described above with respect to FIG. 6.

Processing system 700 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 700 includes one or more processors 702, one or more input/output devices 704, one or more display devices 706, one or more network interfaces 708 through which processing system 700 is connected to one or more networks (e.g., a local network, an intranet, the Internet, or any other group of processing systems communicatively connected to each other), and computer-readable medium 712. In the depicted example, the aforementioned components are coupled by a bus 710, which may generally be configured for data exchange amongst the components. Bus 710 may be representative of multiple buses, while only one is depicted for simplicity.

Processor(s) 702 are generally configured to retrieve and execute instructions stored in one or more memories, including local memories like computer-readable medium 712, as well as remote memories and databases. Similarly, processor(s) 702 are configured to store application data residing in local memories like the computer-readable medium 712, as well as remote memories and data stores. More generally, bus 710 is configured to transmit programming instructions and application data among the processor(s) 702, display device(s) 706, network interface(s) 708, and/or computer-readable medium 712. In certain embodiments, processor(s) 702 are representative of a one or more central processing units (CPUs), graphics processing unit (GPUs), tensor processing unit (TPUs), accelerators, and other processing devices.

Input/output device(s) 704 may include any device, mechanism, system, interactive display, and/or various other hardware and software components for communicating information between processing system 700 and a user of processing system 700. For example, input/output device(s) 704 may include input hardware, such as a keyboard, touch screen, button, microphone, speaker, and/or other device for receiving inputs from the user and sending outputs to the user.

Display device(s) 706 may generally include any sort of device configured to display data, information, graphics, user interface elements, and the like to a user. For example, display device(s) 706 may include internal and external displays such as an internal display of a tablet computer or an external display for a server computer or a projector. Display device(s) 706 may further include displays for devices, such as augmented, virtual, and/or extended reality devices. In various embodiments, display device(s) 706 may be configured to display a graphical user interface.

Network interface(s) 708 provide processing system 700 with access to external networks and thereby to external processing systems. Network interface(s) 708 can generally be any hardware and/or software capable of transmitting and/or receiving data via a wired or wireless network connection. Accordingly, network interface(s) 708 can include a communication transceiver for sending and/or receiving any wired and/or wireless communication.

Computer-readable medium 712 may be a volatile memory, such as a random access memory (RAM), or a nonvolatile memory, such as nonvolatile random access memory (NVRAM), or the like. In this example, computer-readable medium 712 includes a receiving component 714, decomposing component 716, assigning component 718, inputting component 720, storing in database component 722, displaying component 724, using LLM component 726, sending to AI agent component 728, updating persisted state component, and sending answers to summarizer component 732.

In certain embodiments, receiving component 714 is configured to receive input (e.g., questions and answers) from the user 102 via a UI as described above with reference to FIGS. 3 and 6.

In certain embodiments, decomposing component 716 is configured to decompose a multipart question in two or more questions as described above with reference to FIGS. 4A and 6.

In certain embodiments, assigning component 718 is configured to assign questions to AI agents as described above with reference to FIGS. 4A and 6.

In certain embodiments, inputting to AI agent component 720 is configured to input questions and answer received from the user to AI agents as described above with reference to FIGS. 4A-4D, 5, and 6.

In certain embodiments, storing in database component 722 is configured to store the state of the AI agents, questions, follow-up questions, and answer in persisted states in the database 404 as described above with reference to FIGS. 4A-4D, 5, and 6.

In certain embodiments, displaying component 724 is configured to display questions, answers, and response in a UI of a display devices as described above with reference to FIG. 3.

In certain embodiments, using LLM component 726 is configured to using an LLM to summarize answers to questions of a multipart question as described above with reference to FIGS. 4D, 5, and 6.

In certain embodiments, sending answers to summarizer engine component 728 is configured to send answers obtained from AI agents to a summarizer engine as described above with reference to FIGS. 4D, 5, and 6.

In certain embodiments, updating persisted state in database component 730 is configured to update persisted states in the database as described above with reference to FIG. 4D.

Note that FIG. 7 is just one example of a processing system consistent with aspects described herein, and other processing systems having additional, alternative, or fewer components are possible consistent with this disclosure.

### Example Clauses

Implementation examples are described in the following numbered clauses:

Clause 1: A computer-implemented method, comprising: decomposing a multipart question, received from a user via a user interface associated with a device, into two or more questions; assigning each respective question of the two or more questions to an AI agent; for each respective question of the two or more questions: inputting the respective question to the AI agent to generate a follow-up question or an AI agent answer to the respective question; in response to the AI agent generating the follow-up question: displaying the follow-up question to the user via the user interface associated with the device; receiving a user response to the follow-up question from the user via the user interface associated with the device; and inputting the user response to the respective AI agent to generate a AI agent follow-up answer to the follow-up question; using a large language model (LLM) to generate a summary of answers to the two or more questions; and displaying the summary of answers in the user interface associated with the device.

Clause 2: The method of Clause 1, wherein assigning each respective question of the two or more questions to the AI agent comprises creating a mapping of each respective question to one of a plurality of AI agents.

Clause 3: The method of any one of Clauses 1-2, wherein inputting the respective question to the AI agent to generate the follow-up question to the respective question comprises obtaining, as output from the AI agent, the follow-up question to the respective question.

Clause 4: The method of any one of Clauses 1-3, wherein inputting the respective question to the AI agent to generate the follow-up question to the respective question comprises: inputting the respective question to a plugin associated with the AI agent; and obtaining, as output from the plugin, the follow-up question to the respective question.

Clause 5: The method of any one of Clauses 1-4, wherein inputting the respective question to the AI agent to generate the AI agent answer to the respective question comprises: inputting the respective question to the AI agent; and obtaining, as output from the AI agent, the AI agent answer to the respective question.

Clause 6: The method of any one of Clauses 1-5, further comprising: checking a state machine backed up by persistent storage to determine whether the follow-up question was previously answered by the AI agent; and when the follow-up question has been previously asked by the AI agent present the AI agent answer to the user via the user interface.

Clause 7: The method of any one of Clauses 1-6, wherein using the LLM to generate the summary of answers comprises: forming a collection of answers to the two or more questions; inputting the collection of answers to the LLM; and obtaining, as output from the LLM, the summary of answers, wherein the summary of answers is a human readable statement composed of the answers to the two or more questions.

Clause 8: A processing system, comprising: a memory comprising computer-executable instructions; and a processor configured to execute the computer-executable instructions and cause the processing system to perform a method in accordance with any one of Clauses 1-7.

Clause 9: A processing system, comprising means for performing a method in accordance with any one of Clauses 1-7.

Clause 10: A non-transitory computer-readable medium storing program code for causing a processing system to perform the steps of any one of Clauses 1-7.

Clause 11: A computer program product embodied on a computer-readable storage medium comprising code for performing a method in accordance with any one of Clauses 1-7.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
decomposing a multipart question, received from a user via a user interface associated with a device, into two or more questions;
assigning each respective question of the two or more questions to an AI agent;
for each respective question of the two or more questions:
inputting the respective question to the AI agent to generate a follow-up question or an AI agent answer to the respective question;
in response to the AI agent generating the follow-up question:
displaying the follow-up question to the user via the user interface associated with the device;
receiving a user response to the follow-up question from the user via the user interface associated with the device; and
inputting the user response to the respective AI agent to generate a AI agent follow-up answer to the follow-up question;
using a large language model (LLM) to generate a summary of answers to the two or more questions; and
displaying the summary of answers in the user interface associated with the device.

2. The method of claim 1, wherein assigning each respective question of the two or more questions to the AI agent comprises creating a mapping of each respective question to one of a plurality of AI agents.

3. The method of claim 1, wherein inputting the respective question to the AI agent to generate the follow-up question to the respective question comprises obtaining, as output from the AI agent, the follow-up question to the respective question.

4. The method of claim 1, wherein inputting the respective question to the AI agent to generate the follow-up question to the respective question comprises:
inputting the respective question to the AI agent; and
obtaining, as output from the AI agent, the follow-up question to the respective question.

5. The method of claim 1, wherein inputting the respective question to the AI agent to generate the AI agent answer to the respective question comprises:
inputting the respective question to the AI agent; and
obtaining, as output from the AI agent, the AI agent answer to the respective question.

6. The method of claim 1, further comprising:
checking a state machine backed up by persistent storage to determine whether the follow-up question was previously answered by the AI agent; and
when the follow-up question has been previously asked by the AI agent present the AI agent answer to the user via the user interface.

7. The method of claim 1, wherein using the LLM to generate the summary of answers comprises:
forming a collection of answers to the two or more questions;
inputting the collection of answers to the LLM; and
obtaining, as output from the LLM, the summary of answers, wherein the summary of answers is a human readable statement composed of the answers to the two or more questions.

8. A processing system, comprising:
one or more memories comprising computer-executable instructions; and
one or more processors configured to execute the computer-executable instructions and cause the processing system to:
decompose a multipart question, received from a user via a user interface associated with a device, into two or more questions;
assign each respective question of the two or more questions to an AI agent;
for each respective question of the two or more questions:
input the respective question to the AI agent to generate a follow-up question or an AI agent answer to the respective question;
in response to the AI agent generating the follow-up question:
display the follow-up question to the user via the user interface associated with the device;
receive a user response to the follow-up question from the user via the user interface associated with the device; and
input the user response to the respective AI agent to generate a user answer to the follow-up question;
use a large language model (LLM) to generate a summary of answers to the two or more questions; and
display the summary of answers in the user interface associated with the device.

9. The processing system of claim 8, wherein to assign each respective question of the two or more questions to the AI agent, the one or more processors are configured to cause the processing system to create a mapping of each respective question to one of a plurality of AI agents.

10. The processing system of claim 8, wherein to input the respective question to the AI agent to generate the follow-up question to the respective question, the one or more processors are configured to cause the processing system to obtain, as output from the AI agent, the follow-up question to the respective question.

11. The processing system of claim 8, wherein to input the respective question to the AI agent to generate the follow-up question to the respective question, the one or more processors are configured to cause the processing system to:
input the respective question to the AI agent; and
obtain, as output from the AI agent, the follow-up question to the respective question.

12. The processing system of claim 8, wherein to input the respective question to the AI agent to generate the AI agent answer to the respective question, the one or more processors are configured to cause the processing system to:
input the respective question to the AI agent; and
obtain, as output from the AI agent, the AI agent answer to the respective question.

13. The processing system of claim 8, the one or more processors are further configured to cause the processing system to:
check a state machine backed up by persistent storage to determine whether the follow-up question was previously answered by an AI agent; and
when the follow-up question has been previously asked by the AI agent, present the AI agent answer to the user via the user interface.

14. The processing system of claim 8, wherein to using the LLM to generate the summary of answers, the one or more processors are configured to cause the processing system to:
form a collection of answers to the two or more questions;
input the collection of answers to the LLM; and
obtaining, as output from the LLM, the summary of answers, wherein the summary of answers is a human readable statement composed of the answers to the two or more questions.

15. An apparatus, comprising:
a planner configured to decompose a multipart question, received from a user via a user interface associated with a device, into two or more questions;
an executor engine configured to:
input each respective question of the two or more questions to an AI agent to generate a follow-up question to the respective question;
present the follow-up question to the user via the user interface associated with the device;
receive a response to the follow-up question from the user via the user interface associated with the device; and
input the response to the AI agent to generate an answer to the response; and
a summarizer engine configured to generate a summary of answers to the two or more questions and display the summary of answers in the user interface associated with the device.

16. The apparatus of claim 15, wherein to input the respective question to the AI agent to generate the follow-up question to the respective question, the executor engine is configured to obtain, as output from the AI agent, the follow-up question to the respective question.

17. The apparatus of claim 15, wherein to input the respective question to the AI agent to generate the follow-up question to the respective question, the executor engine is configured to:
input the respective question to an AI model; and
obtain, as output from the AI model, the follow-up question to the respective question.

18. The apparatus of claim 15, wherein the executor engine is further configured to obtain, as output from the AI agent, an answer to the respective question.
